(19) United States
(12) Patent Application Publication
(10) Pub. No.: US 2006/0060541 A1
(43) Pub. Date: Mar. 23, 2006

(54) Waste disposal method and apparatus using wet oxidation and deep well injection

(76) Inventor: Armen N. Abazajian, Houston, TX (US)

Correspondence Address: GORDON G. WAGGETT, P.C., 3200 SOUTHWEST FREEWAY, SUITE 2355, HOUSTON, TX, 77027, US

(21) Appl. No.: 10/947,748

(22) Filed: Sep. 23, 2004

(51) Int. Cl. C02F 1/72

(52) U.S. Cl. 210/762

(57) ABSTRACT

The present invention relates generally to waste treatment methodologies and technologies for treatment and disposal of organic wastes. More specifically, in a preferred embodiment of the present invention, there is described a system and methodology for treating organic waste by wet oxidation processes or wet air oxidation processes (carried out on the surface or subsurface) followed by introduction of the treated waste mixture into a disposal well and injection of the mixture into a suitable geological formation. Ideally, the mixture is filtered prior to injection into the formation. The method and apparatus of the present invention provide increased waste treatment throughput as compared to conventional use of wet oxidation or wet air oxidation followed by surface biotreatment.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

The method and apparatus of the present invention relate generally to waste treatment technologies for treatment and disposal of organic wastes. More specifically, in a preferred embodiment of the present invention, there is described a system and methodology for treating organic waste by wet oxidation processes and injection of the treated mixture into a disposal well.

There are two currently practiced technologies which are utilized independently for waste disposal. The first of these technologies is wet air oxidation (WAO) or wet oxidation (WO) (the terms WO and WAO may be used interchangeably herein). Generally speaking, WO is the oxidation of soluble or suspended components in an aqueous environment using oxygen as the oxidizing agent. When air is used as the source of oxygen, the process is often referred to as wet air oxidation (also referred to herein as WAO). Wet air oxidation waste treatment methods consist essentially of the steps of contacting excess air, water and usually a constituent in the waste water that has to be oxidized prior to release of the treated water into the environment or for disposal at temperatures in excess of 100° C. and pressures in the range from about 150 psig and higher. For example, it is reported in the literature that the oxidation reactions occur at temperatures of 150° C. to 320° C. (275° F. to 608° F.), and at pressures from 10 to 220 Bar (150 to 3200 psi). The required operating temperature is often determined by the treatment objectives. Higher temperatures require higher pressure to maintain water in a liquid phase in the system.

As described in U.S. Pat. No. 5,082,571 entitled “Caustic Sulfide Wet Oxidation Process”, Beula et al., which is incorporated herein by reference, there is depicted one such example wet oxidation unit known in the art. Referring to FIG. 1A (prior art), there is shown a schematic flow diagram for a wet oxidation system used, e.g., for treatment of wastes such as caustic sulfide scrubbing liquors. Raw waste, such as caustic sulfide liquor, from a storage tank or other feed source 10 flows through a conduit 12 to a high pressure pump 14 (or other mechanism to create pressure) which pressurizes the liquor. The raw liquor is mixed with a pressurized oxygen-containing gas, supplied by a compressor 16, within a conduit 18. The mixture flows through a heat exchanger 20 where it is heated to a temperature which initiates oxidation. The heated mixture then flows through a second heat exchanger 22 (which may or may not be necessary or required) which provides auxiliary heat for startup of the system. For waste with low COD content, auxiliary heating may need to be continuously applied through the second heat exchanger 22 to maintain the desired operating temperature for the wet oxidation system. The heated feed mixture then enters a reactor vessel 24 which provides a residence time wherein the bulk of the oxidation reaction occurs. The oxidized liquor and oxygen depleted gas mixture then exits the reactor through a conduit 26 controlled by a pressure control valve 28. The hot oxidized effluent traverses the heat exchanger 20 where it is cooled against incoming raw liquor and gas mixture. The cooled effluent mixture flows through a conduit 30 to a separator vessel 32 where liquid and gases are disengaged. The liquid effluent exits the separator vessel 32 through a lower conduit 34 while the gases are vented through an upper conduit 36.

The Zimpro Division of United States Filters Corporation (USFilter) provides a number of wet oxidation technologies. According to USFilter, the typical wet oxidation system is a continuous process using high pressure rotating equipment to raise the feed stream and air (or oxygen) to required operating pressure. Heat exchangers are routinely employed to recover energy contained in the reactor effluent to preheat the feed/air entering the reactor. Auxiliary energy, usually steam, is necessary for startup and can provide trim heat if required. The reactor vessel provides residence time at temperature which enables the oxidation reactions to proceed towards completion. Since the oxidation reactions are exothermic, sufficient energy may be released in the reactor to allow the wet oxidation system to operate without any additional heat input. Typical wet oxidation reactions can convert organic contaminants to carbon dioxide, water and biodegradable short chain organic acids. Inorganic constituents such as sulfides and cyanides can also be oxidized. Wet oxidation can involve any or all of the following reactions:
Organics+O2→CO2+H2O+RCOOH*
Sulfur Species+O2→SO4-2
Organic Cl+O2→Cl-1+CO2+RCOOH*
Organic N+O2→NH3+CO2+RCOOH*
Phosphorus+O2→PO4-3

*short chain organic acids such as acetic acid make up the major fraction of residual organic compounds. See, “ZIMPRO® Wet Oxidation: Innovative Technology for Difficult Problems (2004) brochure by United States Filter Corporation found on USFilter's worldwide website: zimpro.usfilter.com, which is incorporated herein by reference.

Other wet oxidation or WAO processes are described in the art in the following references, which are incorporated herein by reference: (1). Lovo, M. E., Graduate Thesis entitled “Steady State and Transient Behaviour of a Deep-Well Oxidation Reactor”, University of Houston, 1993; (2). U.S. Pat. No. 2,261,921 entitled “Treatment of Waste Materials”, Pittman et al.; (3). U.S. Pat. No. 2,665,249 entitled “Waste Disposal”, Zimmerman et al.; (4). U.S. Pat. No. 3,186,942 entitled “Oxidation of Sulphides in Aqueous Solutions”, Benger; (5). U.S. Pat. No. 3,449,247 entitled “Process for Wet Oxidation of Combustible Waste Materials”, Baur; (6). U.S. Pat. No. 3,761,409 entitled “Continuous Process For the Air Oxidation of Sour Water”, McCoy et al.; (7). U.S. Pat. No. 4,070,281 entitled “Method for Treating Waste Water”, Tagashira et al.; (8). U.S. Pat. No. 4,756,837 entitled “Wet, Pressure, Partial Oxidation of Black Liquor”, Nadezhdin; (9). U.S. Pat. No. 4,399,111 entitled “Process for Removal of Sour Gases by Scrubbing”, Baur et al.; (10). U.S. Pat. No. 4,350,599 entitled “Process for Treatment of Caustic Waste Liquors”, Chowdhury; (11). U.S. Pat. No. 4,767,543 entitled “Oxidation of Wastewaters”, Chornet et al.; (11). U.S. Pat. No. 5,230,810 entitled “Corrosion Control for Wet Oxidation Systems”, Clark, et al.; (12). U.S. Pat. No. 5,298,174 entitled “Low Temperature Caustic Sulfide Wet Oxidation Process”, Momont, et al.; (13). U.S. Pat. No. 4,795,568 entitled “Oxidative Evaporation Process and Apparatus”, Chen; (14). U.S. Pat. No. 3,977,966 entitled “Purification of Non-biodegradable Industrial Wastewaters”, Pradt, et al.; (15). U.S. Pat. No. 6,180,079 entitled “Wet Oxidizing Process”, Shimizu; (16) Dietrich, M J., et al., “Wet Air Oxidation of Hazardous Organics in Wastewater”, Environmental Progress, Vol. 4., No. 3., pp. 171-177 (August 1985); (17) U.S. Pat. No. 6,576,144 B1, Vineyard; (18). “Effluent Caustic Treating Systems Utilizing MERICON™ Technologies”, found on the world wide web at the following website: merichem.com/process/technicalarticles/MericonEffluentCaustic2; (19). Wu, Qiang, et al., “Kinetics study on catalytic wet air oxidation of phenol”, Chemical Engineering Science 58 (2003) 923-928; (20). U.S. Pat. No. 6,017,460 entitled “Heating and Reaction System and Method Using Recycle Reactor”, Eller, et al.; (21). U.S. Pat. No. 5,358,646 entitled “Method and Apparatus for Multiple-Stage and Recycle Wet Oxisation”, Gloyna et al.; (22). U.S. Pat. No. 5,552,039 entitled “Turbulent Flow Cold-Wall Reactor”, McBrayer, Jr., et al.; (23). Document 9-IV-5 entitled “Wet Air Oxidation For Wastewater Treatment” Revised January/2004 published by the Joint Service Pollution Prevention Technical Library maintained by the U.S. Navy on the worldwide web as an html document: p2library.nfesc.navy.mil/P2_Opportunity_Handbook/9-IV-5; and (24). Montana State University (Duffy, James), Project Title: “Enhanced Wet Air Oxidation of PCB Contaminated Sediments”, GLNPO ID: GL2000-164.

Various aqueous waste streams containing hazardous hydrocarbons and incompletely oxidized hazardous or noxious inorganic materials are rendered non-hazardous using wet oxidation or WAO processes. Examples of such aqueous waste streams may include:
Aqueous solutions of sulfidic caustic;
Aqueous streams containing low levels of toxic organic chemicals such as dioxins, Alkyl halides;
Chemical and biological warfare agents;
Paper mill black liquor; and
Aqueous slurry of contaminated activated carbon.

A typical wet air oxidation unit consists of an interchanger, a trim heater and a reactor. The reactor is needed to provide sufficient volume for the oxidation reaction to occur. Because the oxidation reaction is exothermic, it has been calculated that 1% by weight of organics are sufficient to allow autothermal operation of the WAO unit, i.e., no additional heat is required to bring inlet water and air to reaction temperatures and to maintain the reaction mixture at the desired temperature. Thus, interchange of the reactor outlet with the reactor inlet is critical to maintain energy efficiency of the unit.

Wet air oxidation units are expensive. High reaction pressures necessitate heavy gage vessels and piping, while mixture of air and water at high temperatures calls for use of expensive Ni—Cr—Mo steel alloys or cladding of exotic metals such as titanium or nickel. Interchangers in the WAO unit design must provide high exchange area, yet be designed to compensate for frequent plugging problems caused from the precipitation of partially oxidized high melt point solids. WAO units are designed to convert virtually all of the hazardous components fed into the WAO unit into oxidized intermediate products. The products of wet air oxidation of organics may include carbon dioxide as well as short-chain carboxylic acids (formic, acetic, etc.) and other oxygenated short-chain compounds such as glycols, aldehydes, ketones and alcohols. Typically, effluent from WAO units is sent to a water treatment facility for final treatment, disposal and/or reuse where the oxygenated organics are biologically treated to convert all of the remaining oxygenated hydrocarbon structures into settled or filterable biomass, carbon dioxide and water.

The other common waste treatment technology known in the art is deep well disposal. Deep well disposal technology is described in the following references which are incorporated herein by reference: U.S. Environmental Protection Agency (“EPA”) publication No. EPA 813-F-94_{—}002 entitled “Class I Injection Wells and Your Drinking Water”, July 1994; Robbins, James, “Waste fate assured in deep wells”, BIC, May 2004; American Chemical Council, “Deep Well Disposal: An Option For Responsible Management of Chemical Wastes”, which can be found on the worldwide web at the following website: aboutdeepwells.com; American Chemical Council, Frequently Asked Questions about Deep Well Disposal, which can be found on the worldwide web at the following website: aboutdeepwells.com/faq; “Chemical Fate: Nature's Treatment of Injected Wastes”, Chemical Manufacturer's Association, 1300 Wilson Blvd., Arlington, Va. 703-741-5000.

A number of geological formations exist at various depths which consist primarily of permeable sands, or permeable sands with admixtures or occlusions of carbonatious deposits, and which are surrounded by relatively impermeable rock formations. These formations sometimes are oil-bearing. In other cases they are filled with liquid brines. Deep wells typically are constructed with several concentric radial barriers to prevent spillage of wastes above the impermeable rock formations and into the aquifers and water supply regions. A typical well would have cement, steel, in some cases high alloy corrosion resistant steel, and possibly fibreglass liners to present a corrosion-resistant barrier to the injectate. Deep wells normally have several sets of perforations at the depths of the permeable sand formation which allow the injectate to pass into the formation. Aqueous hazardous wastes are pumped into permeable sand formations as much as 5000 to 8000 feet below grade. The pressures at the bottom of the well typically range from 2300 psig to over 3500 psig. Due to the depth of the well, the temperatures are also typically elevated at between 100° F. to 200° F.

The permeable sand formations into which deep wells inject are generally very large and the time to fill these formations with waste or the time for the waste to migrate out of these formations is measured in geological time, i.e., in tens or hundreds of thousands of years. It has been demonstrated that the wastes injected into these reservoirs degrade into non-hazardous components over time. Any such hazardous characteristics as alkalinity and acidity are neutralized by reaction with naturally occurring carbonates and oxides distributed among the sand. Organic components undergo slow reactions similar to those in wet air oxidation where the organic components are oxidized at mild temperatures and high pressures by the oxygen dissolved in the injectate. Additional destruction of organics also takes place due to anaerobic bacterial activity in the formation.

The ability of the deep well to establish high pressures due to the weight of the liquid column and to contain the high pressures due to the pressure of the formation on the casing of the deep well led some of the prior art researchers to combine the concept of the deep well with the wet air oxidation concept. In such systems, aqueous waste is fed through a concentric pipe into a deep well. At or near the bottom of the well the air is injected into the waste stream. Reaction mixture is returned on the outside of the well back to the surface. Thus the deep well reactor also serves as an interchanger exchanging the oxidation heat to the feed waste material. Injection of air occurred at the bottom of the well. Depending on the depth of the well, the reaction may occur either in a supercritical or in subcritical regime. Although a supercritical phase reaction is preferable because of very fast reaction rates and reactions that react essentially to completion, inorganic salts precipitate in supercritical water. Since many waste streams contain inorganic or organic salts in addition to soluble or insoluble organics, the application of supercritical wet air oxidation may be limited. Deep well wet air oxidation has not been used commercially to-date.

For example, U.S. Pat. No. 5,536,385 entitled “Production and Purification of Contaminated Effluent Streams Containing Ammonium Sulfate and Ammonia” (Sheldon et al.), which is incorporated herein by reference, describes one such deep well oxidizer. Referring to FIG. 1B (prior art), there is shown an example deep well oxidation unit 100. A vertical deep well reactor 110 with a vertical chamber 112 is disposed in a bore B, e.g., a wellbore in the earth. An effluent stream to be treated (e.g., any of the effluent streams treated with wet oxidation or WAO processes) flows through a feed input 114 into the vertical chamber 112. Oxygen is fed into the vertical chamber 112 through a hollow movable oxygen inlet tube 116 which has a longitudinal oxygen flow channel therethrough and which is connected to coil tubing 118 of a coil tubing system 120. The oxygen inlet tube has a ceramic tip 117.

The coil tubing system 120 depicted in FIG. 1B is like any typical commercially available coil tubing system and has a tubing injector device 122 which moves the coil tubing (and hence the oxygen inlet tube) up and down in the vertical chamber 112. The coil tubing is stored on a reel unit 124 and power is supplied to the injector device 122 by a power system 126. The oxygen inlet tube can be moved by any suitable means including, but not limited to, a coil tubing system. A hollow ceramic tip for an oxygen inlet tube may range in length between two inches and thirty feet. The use of such tips reduces tube corrosion at the tip, reduces maintenance costs and prolongs tube life. The introduction of oxygen into a high temperature and pressure region of the deep well reactor results in the formation of a highly oxidizing environment starting at the tip of the oxygen inlet tube. This highly oxidizing environment causes the oxygen inlet tube to become corroded and oxidized away in such a manner that it causes the tube to become shorter with time, eventually requiring tube replacement. The rapidity with which this occurs is dependent upon the temperature and pressure in the oxidizing environment. Under conditions of very high temperature and pressure, this oxidation and shortening of the tube can occur in a matter of a few hours. Having an adjustable inlet tube allows finer control of the reaction zone in the reactor. Shortening the tube increases the length of the oxidizing zone in the reactor. Lengthening the tube decreases the length of the reaction zone. As the composition of the stream processed by the deep well reactor is seldom constant, the ability to modify the oxidizing zone in the reactor is a method to compensate for and optimize the destruction efficiency of the organic chemicals present in the stream.

Referring still to FIG. 1B, as a reactor ages, the downcomer tube may also experience corrosion and shortening of length. An adjustable inlet tube allows compensation for this shortening without the need to shut down the reactor and replace the downcomer tube. Scale and sludge accumulate both in the bottom of the reactor and on the sides of the downcomer tube. These accumulations may restrict flow of both oxygen and fluids through the reaction zone. Moving the adjustable oxygen inlet tube allows for continued operation of the reactor without the need to clean the reactor as often as with prior systems. In certain embodiments a coiled tubing unit is used to effect the positioning and movement of the oxygen inlet tube. Use of a coiled tubing unit permits modification of the length of oxygen inlet tube with a minimum amount of reactor downtime. In certain circumstances, e.g., when other than cryogenic fluids are being used as oxidants in a deep well reactor, the tube length is adjusted with no interruption in reactor operation.

Above-ground wet air oxidation (WAO) units, the discharge of which is sent to biotreatement facilities, have to be operated at very high conversions of the incoming hazardous constituent. Oxidation rates as well as any chemical reaction rates usually are proportional to the concentration of the reactants. Wet air oxidation reactors can be generally described as being plug flow reactors. Thus, as the hazardous constituent concentration declines, reaction rates decline and, if the exit concentrations must be extremely low, the residence time in the reactor increases and feed rates to the units decline for a given size unit. Because of high temperatures, high pressures and high corrosion rates, the above ground WAO units are extremely expensive. In some cases the cost can be moderated by maintaining the pH of the reaction mass in the basic range and limit the metallurgy of the unit to an alloyed steel. However, units which handle high concentration of organics are usually titanium or nickel clad.

Deep well WAO units do not require the thickness of the metal to contain the pressure, but they are also expensive because a well has to be drilled. Deep well WAO units are very difficult to maintain. WAO units are known to experience plugging problems. If such problems occur several thousands of feet below ground surface, they would be extremely expensive to repair. Furthermore, deep well WAO units do not solve the problem of having to reduce the effluent concentration of hazardous components to below a required limit for further processing in a water treatment facility. In that respect they are equivalent to the above-ground WAO units.

Deep well waste disposal is limited to streams with low amounts of soluble organics. Insoluble organics, if introduced into the permeable formation, coat the pores in the formation and reduce its permeability thus damaging the formation. Although typically 1-2% of the injectate is organic, all of the organics must be water-soluble.

FIG. 1C generally depicts a deep well disposal system for the injection of wastes which could be employed in various preferred embodiments of the present invention.

As such, there exists a need to provide a system and methodology for treating organic waste by wet oxidation processes and injection of the treated mixture into a disposal well.

### BRIEF SUMMARY OF THE INVENTION

To address the forgoing problems, the present invention teaches a method and apparatus for improving the capability of WAO units to handle organic wastes. In a preferred embodiment of the present invention, there is described a system and methodology for treating organic waste by wet air oxidation processes and injection of the treated mixture into a disposal well. A preferred embodiment of the present invention describes a method and apparatus of treating organic waste initially by wet air oxidation and subsequently by injection of the oxygen-reach aqueous mixture into a deep disposal well.

In a preferred embodiment of the present invention, there is described a waste treatment method comprising the steps of: (a) contacting an aqueous waste stream with a pressurized air stream for a time, at a temperature and at a pressure sufficient to form an oxidizing stream; (b) introducing the oxidizing stream down an injection well, where the oxidizing stream continues to oxidize as the stream proceeds downhole to form an injection stream; and (c) injecting the injection stream into an injection formation. In a preferred embodiment includes the step of contacting the aqueous waste stream with a catalyst. Preferably, the catalyst is a copper salt, manganese salt, iron, strong acid oxidizers, nitric or nitrous group NOx. Additionally, the methods of the present invention can preferably include the step of filtering the oxidizing stream prior to the injecting step. The aqueous waste stream can be introduced into the injection well by employing a mechanical pump or by opening a valve to allow pressure to move the stream, or by other suitable means.

In one preferred embodiment, the waste treatment method includes an air stream comprising air alone, air in combination with other oxidizing agents, or other oxidizing agent(s) alone.

In a preferred embodiment of the present invention, the contacting step of a preferred embodiment of the present methodology occurs in primary surface oxidation unit. In another preferred embodiment, the contacting step occurs in a wet oxidation unit or a wet air oxidation unit. In yet another preferred embodiment, the contacting step occurs in a subsurface oxidation unit.

In one preferred embodiment, the contacting step of the waste treatment method further comprises the steps of: pressurizing the aqueous stream; heating the aqueous stream in a heat exchanger; introducing into the aqueous stream a source of pressurized air or other pressurized oxidizing compound; oxidizing waste components in the aqueous waste stream to form an oxidized aqueous waste stream; flashing the oxidized aqueous waste stream; and phase-separating the non-oxidized waste components in the oxidized aqueous waste stream.

In one embodiment, the injection well preferably is a secondary subsurface oxidation unit. In another preferred embodiment, the contacting step occurs in a subsurface oxidation unit which is either stand-alone or part of the injection well.

A preferred temperature of the contacting step is in the range of 100° C. to 320° C. (212° F. to 608° F.). In another preferred embodiment, the temperature of the contacting step is in excess of 150° C.

A preferred pressure of the contacting step is in the range of 10 to 220 Bar (150 to 3200 psi). In another preferred embodiment, the pressure of the contacting step is in excess of 150 psig.

In a preferred embodiment of the waste treatment methodology, the oxidizing stream is subjected to a pressure in excess of 2000 psig. In another preferred embodiment, the oxidizing stream is subjected to a pressure in the range of about 2000 psig to 4000 psig.

In yet another preferred embodiment of the waste treatment methodology, the oxidizing stream is subjected to a temperature in excess of 100° F. (38° C.). In another preferred embodiment, the oxidizing stream is subjected to a temperature in the range of about 100° F. (38° C.) to about 300° F. (150° C.).

In one preferred embodiment of the waste treatment methodology, the duration of time for the contacting step is in the range of about 15 minutes to 4 hours. In another preferred embodiment, the duration of time for the contacting step, based on temperature and pressure, is sufficient to oxidize waste components in the aqueous waste stream into soluble oxidation products. In yet another preferred embodiment, the residence time of the oxidizing stream in the injection well is in the range of from about 0.05 to about 20 hours. In yet another preferred embodiment, the residence time of the oxidizing stream in the injection well is in the range of from about 0.2 to about 6 hours. In a further preferred embodiment, the residence time in the injection well is sufficient to oxidize the remaining insoluble waste components into soluble oxidation products.

During the operation of the methodology of the present invention, it may be preferred to include the additional step of neutralizing the aqueous waste stream. Such step of neutralization preferably occurs prior to the contacting step and/or prior to the introducing step.

In one preferred embodiment of the present invention, the total reaction time to process the aqueous waste prior to injection is at least between 10% to 60% faster than the reaction time needed to prepare a similar aqueous stream for conventional post WAO biotreatment. In another preferred embodiment, the total reaction time to process the aqueous waste prior to injection is at least between 1.1 to 1.6 times shorter than the reaction time needed to prepare a similar aqueous stream for conventional post WAO biotreatment. In yet another preferred embodiment, the total waste throughput injected into the formation is at least about 11% to 150% higher than the waste throughput for a similar aqueous stream treated using conventional WAO and post WAO biotreatment. In a further preferred embodiment of the present invention, the total waste throughput injected into the formation is at least twice the throughput for a similar aqueous stream treated using conventional WAO, the products of which are released into the environment.

According to one preferred embodiment of the waste treatment methodology of the present invention, the pressure of the contacting step is between 500 to 3500 psig; temperature from 150 to 350° C.; a Cu or Mn catalyst is added; there is achieved a 1% to 300% excess oxygen as compared to COD; and there is achieved a 10-90% rate improvement as compared to conventional WAO/biotreatment combination.

It is anticipated and preferred that the aqueous stream treated by method and apparatus of the present invention contains organic wastes. For example, the aqueous waste stream may contain hazardous hydrocarbons and/or incompletely oxidized hazardous or noxious inorganic materials. The aqueous waste stream may contain one or more of the following contaminants: aromatics, naphthenics, aliphatics, carboxylic acids, alcohols, ketones, aldehydes and variously substituted species thereof, halogenated, nitrated and sulphur-substituted molecules, aqueous solutions of sulfidic caustic, aqueous streams containing low levels of toxic organic chemicals such as dioxins, alkyl halides, chemical and biological warfare agents, paper mill black liquor, or an aqueous slurry of contaminated activated carbon.

In another preferred embodiment of the present invention there is described a method of optimizing the injectability of the effluent product of a wet oxidation or wet air oxidation waste treatment process prior to deep well injection of such product comprising the step of filtering such product prior to such injection.

In another preferred embodiment of the present invention, there is described a waste treatment system comprising: a first reaction zone for receiving and oxidizing a waste stream and creating an effluent stream; a subsurface reaction zone for receiving the effluent stream from the first reaction zone and further oxidizing the effluent stream; and a subsurface geological formation capable of receiving the effluent stream from the subsurface reaction zone. In one preferred embodiment, the first reaction zone is a primary surface oxidation unit. In another preferred embodiment, the first reaction zone is a wet oxidation unit or a wet air oxidation unit. In yet another embodiment, the first reaction zone is a subsurface oxidation unit. In a further preferred embodiment, the first reaction zone is a deep well subsurface reactor. In yet another preferred embodiment, the first reaction zone is a subsurface oxidation unit operating in combination with the subsurface reaction zone.

In one preferred embodiment of the present invention, the first reaction zone comprises the following: a heat exchanger for heating the waste stream; a pump or other source of pressure for pressurizing the waste stream; a source of pressurized air or other pressurized oxidizing compound for introducing into the waste stream; an oxidation reactor for receiving and oxidizing the waste stream; and a flash vessel for receiving an effluent from the oxidation reactor and flashing same.

In yet another preferred embodiment, the waste treatment system of the present invention includes a filtration unit for receiving and filtering the effluent stream from the first reaction zone prior to the effluent stream entering the subsurface reaction zone.

In one preferred embodiment, the subsurface reaction zone is a subsurface oxidation unit. In another preferred embodiment, the subsurface reaction zone is a deep injection well. In still a further embodiment, the subsurface reaction zone is a deep injection well and also serves as the first reaction zone. In yet another preferred embodiment, the first reaction zone is a subsurface oxidation unit and the subsurface reaction zone is a deep injection well. Also, in an additional preferred embodiment, the first reaction zone is a subsurface oxidation unit and the subsurface reaction zone is a deep injection well housing the subsurface oxidation unit.

### BRIEF DESCRIPTION OF THE SEVERAL VIEWS OF THE DRAWINGS

FIG. 1A shows a general schematic for a wet oxidation system known in the art that can be employed in embodiments of the present invention.

FIG. 1B is a schematic of a deep well oxidation unit known in the art that can be employed in embodiments of the present invention.

FIG. 1C is a schematic of a deep well waste injection system known in the art that can be employed in embodiments of the present invention.

FIG. 2 is a schematic diagram of an exemplary waste disposal system for practicing the various aspects of a preferred embodiment of the present invention.

FIG. 3 is a schematic diagram of an exemplary waste disposal system for practicing the various aspects of a preferred embodiment of the present invention.

FIG. 4 is a schematic diagram of an exemplary waste disposal system for practicing the various aspects of a preferred embodiment of the present invention.

FIG. 5 is a schematic diagram of an exemplary waste disposal system for practicing the various aspects of a preferred embodiment of the present invention.

FIG. 6 is a schematic diagram of an exemplary waste disposal system for practicing the various aspects of a preferred embodiment of the present invention.

### DETAILED DESCRIPTION OF THE INVENTION

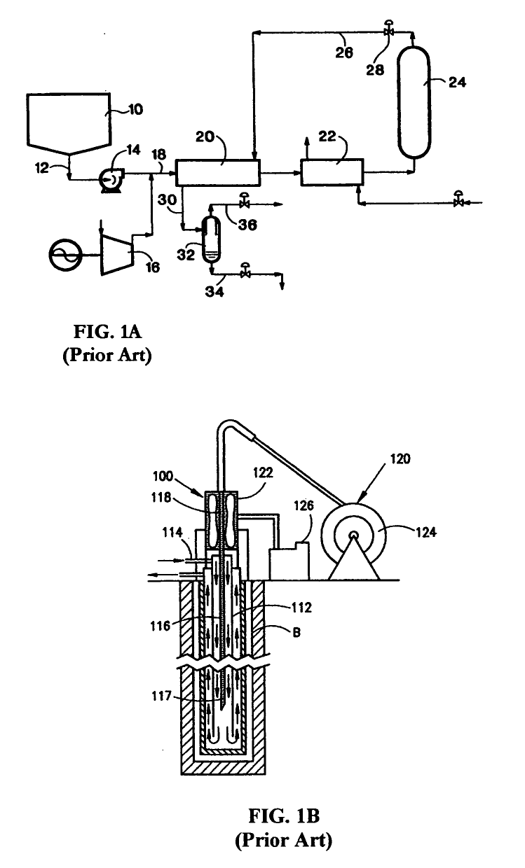

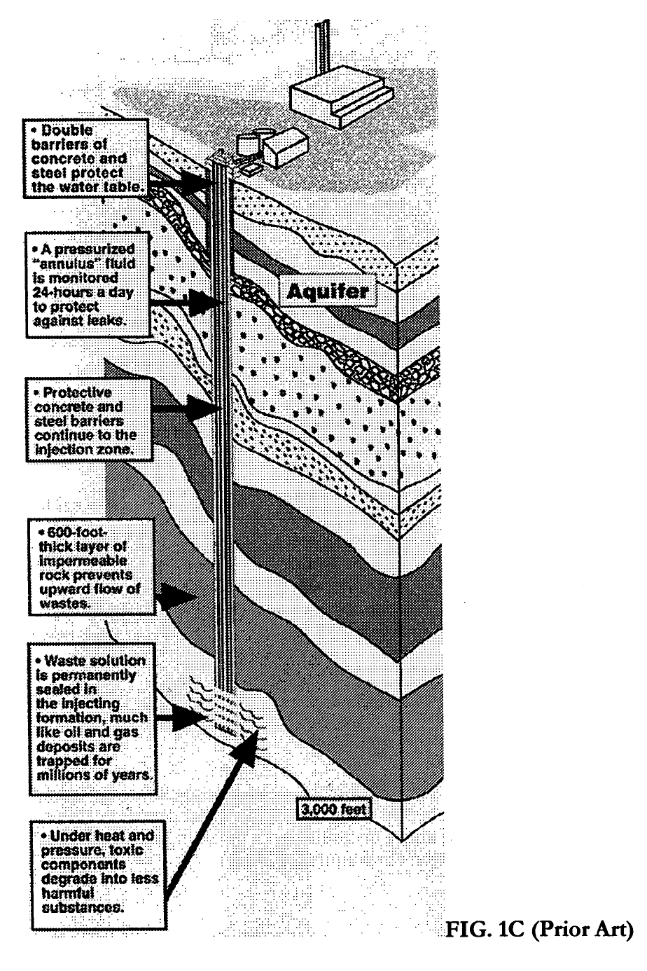

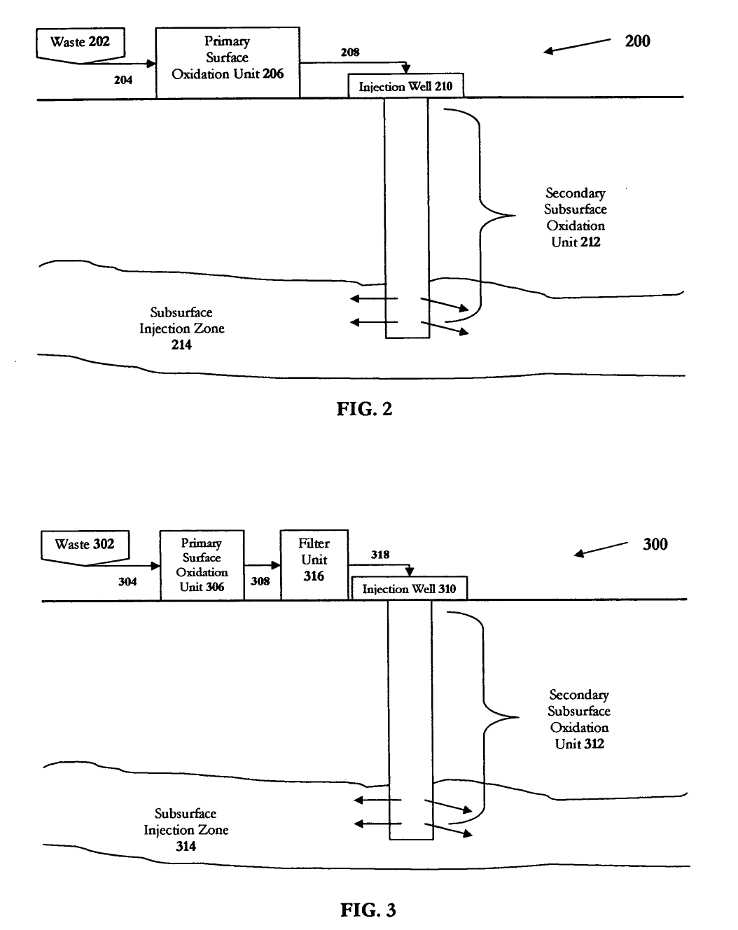

Referring now to FIG. 2 and FIG. 3, in a preferred embodiment of the present invention there is described a dual stage, surface/subsurface oxidation, downhole waste treatment and disposal system 200, 300. In a preferred embodiment of this system for and method of waste treatment, a source of aqueous waste 202, 302 is introduced into a primary surface oxidation unit 206, 306, such as a wet oxidation unit or WAO as described herein (e.g., FIG. A and accompanying text and the other references noted herein) and as is known to those skilled in the art, via conduit 204, 304. After the desired amount of processing or contacting of the waste stream within the surface oxidation unit 206, 306, in a preferred embodiment depicted in FIG. 2, the effluent stream from the oxidation unit 206 is directed into an injection well 210, capable of receiving such treated waste streams, via conduit 208. In an alternate preferred embodiment of the present invention, referring to FIG. 3, the effluent stream from the oxidation unit 306 is directed into a filtration unit 316 via conduit 308 prior to being directed to the injection well 310, capable of receiving such treated waste streams, via conduit 318. Referring again to FIG. 2 and FIG. 3, the subsurface portion of the injection well 210, 310 serves as a secondary oxidation unit 212, 312 to continue the oxidation process started in the primary surface unit 206, 306. The thus treated or contacted waste stream is then injected out of the secondary oxidation unit 212, 312 into a desired subsurface injection zone 214, 314. In a preferred embodiment of the present invention, the injection well is a deep well as is presently known in the art and used in the waste disposal industry, such as that depicted in FIG. 1C, for example. In another preferred embodiment of the present invention, the secondary oxidation unit 212, 312, consists of the tubing, casing, etc. typically found in an injection well, such as a deep well as presently used in the industry for waste disposal (for example, that depicted in FIG. 1C). In yet another preferred embodiment, the secondary oxidation unit 212, 312 employs a deep well reactor, for example, the system described in U.S. Pat. No. 5,536,385 (see, e.g., FIG. 1B and associated text herein) modified such that the effluent stream of such deep well reactor is injected directly into the subsurface injection zone 214, 314 rather than being brought back to the surface for surface disposal.

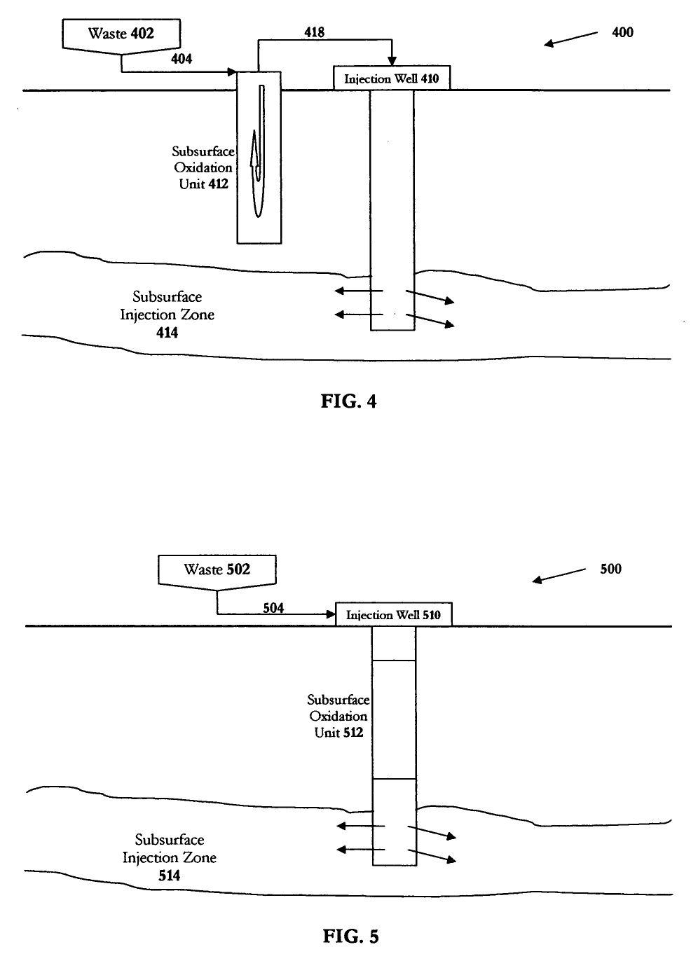

Referring now to FIG. 4, in yet another preferred embodiment of the present waste treatment system 400 and methodology the aqueous waste 402 is introduced into a deep well reactor 412, for example, the system described in U.S. Pat. No. 5,536,385 (see, e.g., FIG. 1B and associated text herein), via conduit 404. The waste stream resides within the deep well reactor for sufficient contact time to treat the waste to the desired end product(s) at which time, the effluent from the deep well reactor 412 is directed from reactor 412 into an injection well 410, capable of receiving such treated waste streams, via conduit 418 (shown here on the surface, but such conduit could be run subsurface if desired). In an alternate preferred embodiment of the present invention, the effluent stream from the deep well reactor 412 is directed into a filtration unit (not shown) prior to being directed to the injection well 410. The thus-treated waste stream is then injected out of the injection well 410 into a desired subsurface injection zone 414. In a preferred embodiment of the present invention, the injection well 410 is a deep well as is presently known in the art and used in the waste disposal industry, such as that depicted in FIG. 1C, for example.

Referring now to FIG. 5, in yet another preferred embodiment of the present waste treatment system invention 500 and methodology, the aqueous waste 502 is introduced into a deep well reactor 512, for example, the system described in U.S. Pat. No. 5,536,385 (see, e.g., FIG. 1B and associated text herein), via conduit 504. However, the effluent stream of the reactor 512 is not directed back to the surface, but instead, much like with an injection well, is injected into the desired subsurface injection zone 514. In this embodiment, the waste stream resides within the deep well reactor 512 for sufficient contact time to treat the waste to the desired end product(s) at which time, the effluent from the deep well reactor 512 is directed from reactor 512 into the injection zone 514. In an alternate preferred embodiment of the present invention, the deep well reactor 512 coexists within the same downhole wellbore as the injection well 510 the effluent stream from the deep well reactor 412 is directed into a filtration unit (not shown) prior to being directed to the injection well 410. The thus-treated waste stream is then injected out of the injection well 410 into a desired subsurface injection zone 414. In a preferred embodiment of the present invention, the injection well 414 is a deep well as is presently known in the art and used in the waste disposal industry, such as that depicted in FIG. 1C, for example.

In yet another preferred embodiment of the present invention, the waste streams, e.g., 202, 302, 402, 502 can come from multiple sources (not shown). Also, in alternate preferred embodiments, multiple primary oxidation units, e.g., 206, 306, multiple subsurface oxidation units, e.g., 212, 312, 412, 512 and multiple injection wells 210, 310, 410, 510 can be employed together or in combination. One or more injection wells can be employed in conjunction with each or such plurality of primary oxidation units; one or more oxidation units can be employed with each or such plurality of injection wells. In a preferred embodiment of the present invention, the waste stream is filtered prior to injection in the subsurface injection zone.

In yet another preferred embodiment, the operations noted herein could take place off-shore, where, for example, the primary surface oxidation unit is mounted on a platform or seagoing vessel. Likewise, the injection well could be located offshore or onshore.

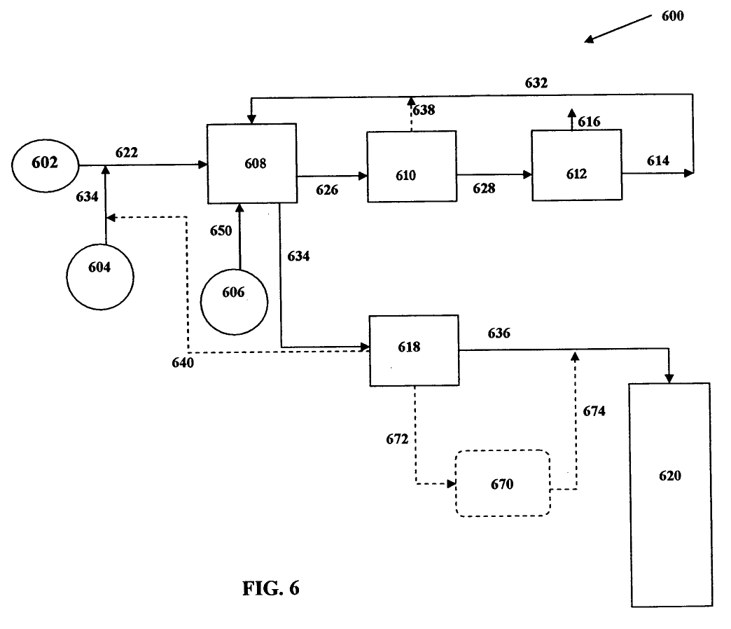

Referring to FIG. 6, there is depicted another preferred embodiment of the present waste treatment system 600 and waste treatment methodology. An aqueous stream 602 is pumped or pressurized to a pressure ranging ideally between 200 and 3000 psig and combined or contacted with a designed ratio of waste organics 604 introduced via conduit 634. Preferably, this ratio may be from about 0.001% by weight to about 30% by weight of organics as a percent of combined streams. The organics introduced into the stream may comprise aromatics, naphthenics, aliphatics, carboxylic acids, alcohols, ketones, aldehydes and variously substituted species thereof, possibly including halogenated, nitrated and sulphur-substituted molecules. In an alternative embodiment an oxidation catalyst may be used. Examples of oxidation catalysts are Cu and Mn salts as well as strong acid oxidizers such as nitric or nitrous groups. The combined aqueous and organic stream is fed via conduit 622 into a WAO unit where the stream is mixed or contacted preferably with from about 5% to 400% stoichiometric excess pressurized air 606 introduced via conduit 650 and preheated in the feed/effluent interchanger 608 to temperatures ranging ideally from about 100° C. to 400° C. Following interchange with the reactor effluent, the preheated mixture is introduced into a reactor 610 via conduit 626 where sufficient residence time is provided to convert a majority of the organics contained in the feed stream into various forms of oxidized hydrocarbons. For example, an aliphatic straight-chain hydrocarbon may oxidize completely to carbon dioxide and water:
CH₃—(CH₂₎ₙ—CH₃+(2n+5)O₂→(n+2)OC₂+(n+3)H₂O

The reaction occurs via free radical mechanism. The initiation of the reaction occurs when an oxygen radical reacts with water to form hydrogen peroxide and therefore a hydroxyl radical, which, in turn, reacts with the organics in the mixture to form organic peroxides and radicals. Reaction propagation occurs via the hydroxyl radical intermediate:
O═O→O.+O.
O.+HOH→2HO. Initiation
HO.+R—H→R.+HOH Propagation
R.+.OH→ROH Termination

At most typical reaction conditions, hydrocarbons are typically further oxidized to highly oxidized carbon-containing species, such as carboxylic acids and carbon dioxide. The extent of reaction of organics as well as inorganic materials in the wet air oxidation units is often measured by a fraction of chemical oxygen demand (COD), i.e., amount of oxygen consumed by a particular oxidation versus the total amount of oxygen that is capable of being consumed by oxidation of a particular sample entirely to the highest oxidation state. For organics, the most oxidized state is carbon dioxide. Thus, 80% of COD means that 80% of total possible oxygen was consumed for oxidation. Also, because initially oxidation tends to break down various organic components into shorter-chain aliphatic alcohols, aldehydes, ketones, diols and carboxylic acids, the hydrocarbon components in the feed may be fully converted to these species at a relatively low fraction of COD. For example, 99.99% destruction of nonane may be noted at 90% of COD.

In the oxidation reactor 610 the temperature of the reaction mixture may increase as the organics oxidize. The temperature gain across the reactor may be from about 1° C. to 200° C. The temperature gain in the reactor 610 may be controlled by the choice of reaction pressure, which can be set at a value such that any heat of oxidation of organics over a certain value may be controlled by partial vaporization of the aqueous/organic reaction mixture. In such a manner, as much as about 0.1 to 50% of the reaction mass may be vaporized by the heat of oxidation. Vaporization must be controlled at a sufficiently low level as not to allow precipitation of salts contained in the stream. The outlet of the reactor 610 is fed, via conduit 628 to a flash vessel 612 where excess oxygen, nitrogen, carbon dioxide and potentially light organics (stream 616) are flashed at a pressure lower than the reactor pressure and ranging from about 3000 psig to 50 psig. The vapour overhead is sent off (616) and the liquid aqueous mixture 614 is sent to the feed heat interchanger 608 via conduit 632. After interchanging the heat with the feed stream, the reactor products are sent to the settling vessel 618 via conduit 634.

In a preferred alternative embodiment, the reactor outlet is interchanged with the feed in the feed effluent exchanger 608 via conduit 638 before it is flashed in flash unit 612.

Remaining insoluble organics are phase-separated in the settling vessel 618. After phase separation of the organics, the aqueous phase is sent, via conduit 636 to deep well 620.

In another preferred embodiment, the accumulated organics from the separator 618 are optionally recycled to the feed organics 604 via conduit 640 or metered into the deep well (secondary oxidation reactor) 620 for further processing and ultimate disposal, via injection, into the subsurface geological formation (injection zone) (not shown) adjacent the deep well.

In yet another alternative embodiment of the present invention, the flash 612 vessel and reactor 610 may be the same physical vessel.

In yet another embodiment of this invention, the reactor outlet is first used to make steam prior to interchange with the feed.

In yet another alternative, the flash vessel overheads 616 are used to make steam.

Although FIG. 6 depicts a preferred embodiment of the present invention, it will become apparent from the disclosure herein that additional WOA units (reactors, settlers, interchangers, flash vessels, filters, etc.) can be used in series or parallel, and/or in combinations, to achieve the desired end product(s) to be injected in a disposal well/secondary reactor.

In yet another preferred embodiment of the present invention, the effluent from the separator 618 is directed, via conduit 672 to a filtration unit 670 after which, the filtered effluent is directed, via conduit 674, 363 to the deep well (secondary oxidation reactor) 620 for further processing and ultimate disposal, via injection, into the subsurface geological formation (injection zone) (not shown) adjacent the deep well.

In a preferred embodiment, the reaction mixture which is sent to the deep well 120 is at a sufficient pressure as to preferably maintain an active reaction mixture in solution, such mixture preferably containing dissolved oxygen and CO₂, peroxides, carboxylic acids, aldehydes, ketones, alcohols, diols, catalysts, water, and soluble portions of remaining feed hydrocarbons. The mixture composition will vary depending on the waste stream, the preference being, however, that the oxygen containing species remain in solution. Of the hydrocarbon species present it is reported in the prior art that highly oxidized species, such as carboxylic acids, dominate. Thus the crude reaction product sent to the well contains not only oxygen which is physically dissolved in the liquid at the still elevated pressures but also oxygen which is chemically bound.

Waste deep well injection tubing may be of a size from about 1″ diameter to 12″ diameter, more typically from 2″ diameter to 6″ diameter. Class 1 EPA hazardous waste deep well assembly typically includes a number (from about 2 to about 5) of concentric casings possibly consisting of steel, high-alloy steel and other corrosion-resistant materials, such as fibreglass, Teflon, Kevlar, etc. Some of the casings are separated by barrier fluids. These casings and barrier fluids are needed to assure that the waste pumped down the well does not spill and contaminate water-bearing layers above the impermeable layers of rock which occlude the permeable formations where wastes are injected.

The waste materials are typically injected, via these wells, into occluded permeable sand formations typically between 5000 to 8000 feet below grade. The volume of injection piping needed to reach such depths could be from about 800 gallons to about 12,000 gallons. Depending on the injection rate, the residence time in the injection piping could be from about 0.05 hours to about 20 hours, more typically from about 0.2 hours to about six hours. As the crude reaction product from the wet oxidation unit, WAO unit (primary oxidation unit) is introduced into the injection piping, the process of oxidation continues until the dissolved and chemically bound oxygen is consumed. The residence time available in the injection piping is on the same order of magnitude that is typically required in the wet oxidation/WAO units (typically from about 15 minutes to about 3 to 4 hours). However, as opposed to the wet oxidation/WAO units where excess oxygen or air is maintained, the well may or may not have sufficient excess air to go to very high conversions of chemical oxygen demand (COD). In the case of the dissolved oxygen, the organic compounds continue to be oxidized in the injection piping until the dissolved oxygen is consumed. In the case of the chemically bound oxygen, the highly oxidized species such as peroxides, carboxylic acids and diols give up oxygen to non-oxidized species to form mildly oxidized hydrocarbons such as alcohols, aldehydes and ketones. The typical pressure at the level where the material exits the pipe through perforations and permeates into the formation may preferably be from about 2000 psig to about 4000 psig. The formation temperatures also may preferably be from about 100° F. (38° C.) to about 300° F. (150° C.) depending on the location. At these temperatures and pressures, the reaction is continuing to occur even in the formation itself where the organic species are continuing to be oxidized until absence of oxygen limits the reaction. At that point, continued degradation of organics occurs by anaerobic bacteria.

Waste disposal wells function by filling voids of the formation and by displacement of brine which saturates permeable occluded formations. It is vitally important for a functioning disposal well to maintain good permeability of the formation into which it injects. Therefore, typically all of the materials that are injected are filtered and potentially otherwise conditioned prior to injection. The permeability of the formation has much to do with wetting of the essentially silicon dioxide and calcium carbonate granules. Thus presence of non-water soluble or non-hydrophilic organics in the formation may prevent wetting of the formation pores and therefore impede permeability of the formation. Thus while prior art lists that as much as 2% of the injectate may be organic (e.g., Robbins, James, “Waste fate assured in deep wells”, BIC, May 2004 shows that in the particular case of one well, 1.6% of the injectate is organic), virtually all of it must be soluble organics.

The oxidation characteristics of the wet oxidation WAO system make it an ideal feed conditioning process for the deep well disposal. Firstly, the oxidation of organics in the wet oxidation/WAO process results in short-chain oxygen containing species which are predominantly highly water soluble. Secondly, the presence of such oxygen-containing hydrocarbon species, which have varying degrees of lipophilic and hydrophilic tendencies, enhances the solubility of the non-oxidized hydrocarbon species. Thirdly, the significant concentrations of physical and chemical oxygen in the wet oxidation/WAO reaction mass are available to continue the oxidation reaction in the injection pipe (secondary reactor) and, indeed, in the formation itself, thus increasing the effective residence time of the wet oxidation/WAO unit thereby reducing the potential for damage to the formation.

Typically, the outlet of WO/WAO units of prior art is released into the environment or sent to biological water treatment. In these cases the toxic organic constituents in an aqueous stream must be converted to a very high conversion level before the product of WO/WAO is introduced into a biotreatment process. Conversely, the limit of conversion of toxic hydrocarbon constituents is set by their solubility limit at the bottom of the deep well in the case of an integrated WAO/deep well process. In many cases, the solubility limits of the toxic chemicals are considerably higher than the maximum allowable waste water discharge limits. Even if the outlet of a wet oxidation/WAO unit is directed to a biotreatment facility, typically commercial biotreatment facilities allow aqueous streams containing from about 5000 to about 30000 ppm COD. If one assumes that all of the COD is attributable to organics, that roughly corresponds to 0.15 to 1% organics allowed in the feed to a biotreatment facility. Thus, the reaction time needed to convert sufficient organics to condition the wet oxidation/WAO outlet stream for a biotreatment facility could be as much as 1.7 times longer to about the same as the reaction time needed to condition the stream for deep well disposal.

In a preferred embodiment of the present invention, the reaction times to process the stream in a WO/WAO unit in an integrated WO/WAO/deep well system could be 1.1 to 1.6 times shorter than the reaction times needed to prepare the stream for biotreatment via WO/WAO processing. Since residence time in a reactor is related to a unit feed rate as
tᵣ=V/Q,
where V is reactor volume and Q is the volumetric flow rate, the potential feed rates to an integrated WAO/deep well unit could be 10% to 60% higher, thus greatly improving the economics of operating the WO/WAO process.

Furthermore, the above calculation does not include the consideration of an additional reaction volume contributed by the deep well injection piping (secondary reactor). If that is taken into consideration, the throughput of the integrated WO/WAO/deep well unit to process aqueous/organic streams can be further increased by about 1% to about 90%, resulting from a total increase due to the solubility considerations and increased reactor volume considerations from about 11% to about 150% increase in throughput as compared to a typical WO/WAO unit that is discharged to a biotreatment facility given the same aqueous/organic mixture.

If the rates possible in an integrated WAO/deep well unit are compared with the rates in a stand-alone WAO unit, the output of which is released into the environment, the rates through the integrated WAO/deep well unit can be from about 2 times and more higher, depending on the allowable concentration of the toxic material in the treated wastewater released into the waterways.

Referring again to the filtration units described in connection with the Figures, yet another benefit which can be derived from integration of WO/WAO and deep well technologies relates to conditioning of the deep well injection stream via filtration. Many waste streams are emulsions containing suspended solids, e.g., three-phase oil/water/solids emulsions. The solids might include organic polymer particles. As such, the waste stream is difficult to filter—the resulting filter cake is blinded by organics thus slowing the filtration process. To preserve the permeability of the formation where the waste is injected, solids-containing crude waste streams are typically filtered. Very often, filtration is difficult because the solids are emulsified in the waste stream with heavy insoluble organics exhibiting surfactant or even solids-suspension characteristics. If the deep well injection feed streams are conditioned by wet air oxidation before filtration, oxidation of organics will break down long-chain organics that are difficult to filter into gaseous CO₂ and short-chain water-soluble organics which do not hinder filtration. As such, a preferred embodiment of the present waste treatment system includes one or more filtration units for filtering the effluent stream prior to injection into the subsurface formation. Likewise, in a preferred embodiment of the present waste treatment methodology, the waste stream is filtered prior to injection into the subsurface formation.

### EXAMPLE 1

Dietrich, et al., Environmental Progress, Vol. 4, No. 3, (Aug. 1985) shows that toluene at a starting concentration of 0.433% can be oxidized at 275° C. for 60 minutes to a 99.7% destruction to a final concentration of 0.0012%. It is reasonable to assume that 0.0012% is also the maximum desired limit of concentration of toluene in waste water. However, the toluene solubility limit in water is 0.05%. Assuming a first order equation where the rate equation is
−d[R]/dt=k[T],
where [T] is concentration of toluene at any time and k is the reaction rate constant. This assumption can be made if oxygen is assumed to be in large excess and its concentration in the liquid phase is effectively not changing near the end of the reaction. As such, then, the reaction time can be solved from an equation:
kt=ln([To]/[T])
where [To] is the initial concentration of toluene. For purposes of comparison, [To] is a constant. Then, the reaction time to reach soluble concentration shall be 2.8 times shorter than the time needed to reach the maximum allowed discharge limit.

### EXAMPLE 2

Emulsions containing high levels of heavy hydrocarbons would tend to have similar filtration rates to mineral oil slurries. After wet air oxidation, the organics would be degraded to low viscosity water-soluble species and the filtration rates would resemble those for water with small amount of solids. Examination of filtration rates in a filter press shows:

| | Average rate, |
|---|---|
| Material Filtered | gal/min/ft² |
| Water with small amount of solids | 60-120 |
| Mineral oil | 20-40 |

Perry's Chemical Engineers' Handbook, Fifth Edition, 1973, pp. 19-67.

A preferred embodiment of the present invention teaches an integration of WO/WAO with deep well injection resulting in increased processing rates of WO/WAO. Ranges mentioned above and pertaining to oxidation conditions, deepwell geometry, etc., are merely exemplary of preferred embodiments of the invention and are not intended to limit the invention.

Based on the foregoing teachings, it will be apparent that numerous permutations of the present invention are possible, for example, and not by limitation:

(a) Processing of waste stream in surface or subsurface WAO (primary reactor), with heat interchange of products and feedstocks, flash, oil settling, oil recycle, and the injection via the deep well (secondary reactor);

(b) Processing of waste stream in surface or subsurface WAO (primary reactor), heat interchange, flash, oil settling, oil recycle, and injection via the deep well (secondary reactor).

(c) Neutralization of waste stream, processing in surface or subsurface WAO (primary reactor), heat recovery (steam), heat interchange, flash, oil settling, oil recycle, and injection via deep well (secondary reactor).

(d) Neutralization of waste stream, processing in surface or subsurface WAO, flash, heat recovery of liquid and flash vapour, heat interchange, oil settling, oil recycle, and injection via deep well (secondary reactor).

(e) Neutralization of waste stream, processing in surface or subsurface WAO, flash, heat recovery of liquid and flash vapour, heat interchange, and injection via deep well (secondary reactor).

(f) Processing in surface or subsurface WAO, heat recovery, flash, and injection via deep well (secondary reactor).

(g) Neutralization of waste stream, processing in surface or subsurface WAO, heat recovery, flash, and injection via deep well (secondary recovery).

(h) All of the above with unconverted oil injection into deep well.

(i) All of the above with flash and WAO conducted in the same physical vessel.

(j) Improvement of WAO rates from about 1% to 500%, and preferably, at least from about 11% to about 150% as compared to WAO/biotreatment combination.

(k) Use of catalysts, such as Cu, Mn, Fe, and NOx.

(l) A preferred operations sequence is: neutralization, WAO, flash, heat recovery with flash overheads and bottoms, heat interchange between bottoms of the flash and feed, oil settling, oil recycling, injection.

(m) Preferred WAO conditions include: pressure 500 to 3500 psig; temperature from 150 to 350° C.; Cu or Mn catalyst addition; 1% to 300% excess oxygen as compared to COD; 10-90% rate improvement as compared to WAO/biotreatment combination.

(n) Preferred flash conditions: 0.01-0.99 of WAO reactor pressure.

All references referred to herein are incorporated herein by reference. While the apparatus and methods of this invention have been described in terms of preferred embodiments, it will be apparent to those of skill in the art that variations may be applied to the process and system described herein without departing from the concept and scope of the invention. All such similar substitutes and modifications apparent to those skilled in the art are deemed to be within the scope and concept of the invention. Those skilled in the art will recognize that the method and apparatus of the present invention has many applications, and that the present invention is not limited to the representative examples disclosed herein. Moreover, the scope of the present invention covers conventionally known variations and modifications to the system components described herein, as would be known by those skilled in the art. While the apparatus, compositions and methods of this invention have been described in terms of preferred or illustrative embodiments, it will be apparent to those of skill in the art that variations may be applied to the process described herein without departing from the concept and scope of the invention. All such similar substitutes and modifications apparent to those skilled in the art are deemed to be within the scope and concept of the invention as it is set out in the following claims.

What is claimed is:

1. A waste treatment method comprising the steps of:
(a) contacting an aqueous waste stream with a pressurized air stream for a time, at a temperature and at a pressure sufficient to form an oxidizing stream;
(b) introducing the oxidizing stream down an injection well, where the oxidizing stream continues to oxidize as the stream proceeds downhole to form an injection stream; and
(c) injecting the injection stream into an injection formation.

2. The waste treatment method of claim 1 further comprising the step of contacting the aqueous waste stream with a catalyst.

3. The waste treatment method of claim 2 wherein the catalyst is a copper salt, manganese salt, iron, strong acid oxidizers, nitric or nitrous group NOx.

4. The waste treatment method of claim 1 further comprising the step of filtering the oxidizing stream prior to the injecting step.

5. The waste treatment method of claim 1 wherein the aqueous waste stream is introduced into the injection well by employing a mechanical pump or by opening a valve to allow pressure to move the stream.

6. The waste treatment method of claim 1 wherein the air stream comprises air alone, air in combination with other oxidizing agents, or other oxidizing agents.

7. The waste treatment method of claim 1 wherein the contacting step occurs in primary surface oxidation unit.

8. The waste treatment method of claim 1 wherein the contacting step occurs in a wet oxidation unit or a wet air oxidation unit.

9. The waste treatment method of claim 1 wherein the contacting step occurs in a subsurface oxidation unit.

10. The waste treatment method of claim 1 wherein the contacting step further comprises the steps of:
a. pressurizing the aqueous stream;
b. heating the aqueous stream in a heat exchanger;
c. introducing into the aqueous stream a source of pressurized air or other pressurized oxidizing compound;
d. oxidizing waste components in the aqueous waste stream to form an oxidized aqueous waste stream;
e. flashing the oxidized aqueous waste stream; and
f. phase-separating the non-oxidized waste components in the oxidized aqueous waste stream.

11. The waste treatment method of claim 1 wherein the injection well is a secondary subsurface oxidation unit.

12. The waste treatment method of claim 1 wherein the contacting step occurs in a subsurface oxidation unit.

13. The waste treatment method of claim 11 wherein the contacting step occurs in the subsurface oxidation unit.

14. The waste treatment method of claim 1 wherein the temperature of the contacting step is in the range of 100° C. to 320° C. (212° F. to 608° F.)

15. The waste treatment method of claim 1 wherein the temperature of the contacting step is in excess of 150° C.

16. The waste treatment method of claim 1 wherein the pressure of the contacting step is in the range of 10 to 220 Bar (150 to 3200 psi).

17. The waste treatment method of claim 1 wherein the pressure of the contacting step is in excess of 150 psig.

18. The waste treatment method of claim 1 wherein the oxidizing stream is subjected to a pressure in excess of 2000 psig.

19. The waste treatment method of claim 1 wherein the oxidizing stream is subjected to a pressure in the range of about 2000 psig to 4000 psig.

20. The waste treatment method of claim 1 wherein the oxidizing stream is subjected to a temperature in excess of 100° F. (38° C.).

21. The waste treatment method of claim 1 wherein the oxidizing stream is subjected to a temperature in the range of about 100° F. (38° C.) to about 300° F. (150° C.).

22. The waste treatment method of claim 1 wherein the duration of time for the contacting step is in the range of about 15 minutes to 4 hours.

23. The waste treatment method of claim 1 wherein the duration of time for the contacting step, based on temperature and pressure, is sufficient to oxidize waste components in the aqueous waste stream into soluble oxidation products.

24. The waste treatment method of claim 1 wherein the residence time of the oxidizing stream in the injection well is in the range of from about 0.05 to about 20 hours.

25. The waste treatment method of claim 1 wherein the residence time of the oxidizing stream in the injection well is in the range of from about 0.2 to about 6 hours.

26. The waste treatment method of claim 1 wherein the residence time in the injection well is sufficient to oxidize the remaining insoluble waste components into soluble oxidation products.

27. The method according to claim 1 including the additional step of neutralizing the aqueous waste stream.

28. The method according to claim 1 including the additional step of neutralizing the aqueous waste stream prior to the contacting step.

29. The method according to claim 1 including the additional step of neutralizing the aqueous stream prior to the introducing step.

30. The method of claim 1 wherein the total reaction time to process the aqueous waste prior to injection is at least between 10% to 60% faster than the reaction time needed to prepare a similar aqueous stream for conventional post WAO biotreatment.

31. The method of claim 1 wherein the total reaction time to process the aqueous waste prior to injection is at least between 1.1 to 1.6 times shorter than the reaction time needed to prepare a similar aqueous stream for conventional post WAO biotreatment.

32. The method of claim 1 wherein the total waste throughput injected into the formation is at least about 11% to 150% higher than the waste throughput for a similar aqueous stream treated using conventional WAO and post WAO biotreatment.

33. The method of claim 1 wherein the total waste throughput injected into the formation is at least twice the throughput for a similar aqueous stream treated using conventional WAO, the products of which are released into the environment.

34. The method of claim 1 wherein the pressure of the contacting step is between 500 to 3500 psig; temperature from 150 to 350° C.; a Cu or Mn catalyst is added; there is achieved a 1% to 300% excess oxygen as compared to COD; and there is achieved a 10-90% rate improvement as compared to conventional WAO/biotreatment combination.

35. The method of claim 1 wherein the aqueous stream contains organic wastes.

36. The method of claim 1 wherein the aqueous stream contains hazardous hydrocarbons and/or incompletely oxidized hazardous or noxious inorganic materials.

37. The method of claim 1 wherein the aqueous stream contains one or more of the following contaminants: aromatics, naphthenics, aliphatics, carboxylic acids, alcohols, ketones, aldehydes and variously substituted species thereof, halogenated, nitrated and sulphur-substituted molecules, aqueous solutions of sulfidic caustic, aqueous streams containing low levels of toxic organic chemicals such as dioxins, alkyl halides, chemical and biological warfare agents, paper mill black liquor, or an aqueous slurry of contaminated activated carbon.

38. A method of optimizing the injectability of the effluent product of a wet oxidation or wet air oxidation waste treatment process prior to deep well injection of such product comprising the step of filtering such product prior to such injection.

39. A waste treatment system comprising:
(a) a first reaction zone for receiving and oxidizing a waste stream and creating an effluent stream;
(b) a subsurface reaction zone for receiving the effluent stream from the first reaction zone and further oxidizing the effluent stream; and
(c) a subsurface geological formation capable of receiving the effluent stream from the subsurface reaction zone.

40. The waste treatment system of claim 39 wherein the first reaction zone is a primary surface oxidation unit.

41. The waste treatment system of claim 39 wherein the first reaction zone is a wet oxidation unit or a wet air oxidation unit.

42. The waste treatment system of claim 39 wherein the first reaction zone is a subsurface oxidation unit.

43. The waste treatment system of claim 39 wherein the first reaction zone is a deep well subsurface reactor.

44. The waste treatment system of claim 39 wherein the first reaction zone is a subsurface oxidation unit operating in combination with the subsurface reaction zone.

45. The waste treatment system of claim 39 wherein the first reaction zone comprises the following:
a. a heat exchanger for heating the waste stream;
b. a pump or other source of pressure for pressurizing the waste stream;
c. a source of pressurized air or other pressurized oxidizing compound for introducing into the waste stream;
d. an oxidation reactor for receiving and oxidizing the waste stream; and
e. a flash vessel for receiving an effluent from the oxidation reactor and flashing same.

46. The waste treatment system of claim 39 further comprising a filtration unit for receiving and filtering the effluent stream from the first reaction zone prior to the effluent stream entering the subsurface reaction zone.

47. The waste treatment system of claim 39 wherein the subsurface reaction zone is a subsurface oxidation unit.

48. The waste treatment system of claim 39 wherein the subsurface reaction zone is a deep injection well.

49. The waste treatment system of claim 39 wherein the subsurface reaction zone is a deep injection well and also serves as the first reaction zone.

50. The waste treatment system of claim 39 wherein the first reaction zone is a subsurface oxidation unit and the subsurface reaction zone is a deep injection well.

51. The waste treatment system of claim 39 wherein the first reaction zone is a subsurface oxidation unit and the subsurface reaction zone is a deep injection well housing the subsurface oxidation unit.
